(19) United States
(12) Patent Application Publication
(10) Pub. No.: US 2026/0338985 A1
(43) Pub. Date: Oct. 29, 2026

(54) FORMATION CHARACTERIZATION VIA IN-PHASE AND QUADRATURE CONDUCTIVITIES

(71) Applicant: SCHLUMBERGER TECHNOLOGY CORPORATION, Sugar Land, TX (US)

(72) Inventors: John RASMUS, Sugar Land, TX (US); Dean M. HOMAN, Sugar Land, TX (US); Gong Li WANG, Sugar Land, TX (US); Denis HELIOT, Sugar Land, TX (US)

(21) Appl. No.: 19/103,840

(22) PCT Filed: Aug. 9, 2023
(86) PCT No.: PCT/US2023/071914

§ 371 Date: Feb. 14, 2025

Related U.S. Application Data
(60) Provisional application No. 63/398,690, filed on Aug. 17, 2022.

(51) Int. Cl. G01V 3/30; G01V 3/38

(52) U.S. Cl. CPC G01V 3/30; G01V 3/38

(57) ABSTRACT

A method can include acquiring electromagnetic conductivity measurements for in-phase conductivity and quadrature conductivity using an electromagnetic conductivity tool disposed in a borehole of a formation that includes particles, where energy emissions of the electromagnetic conductivity tool polarize the particles; inverting a model, using the electromagnetic conductivity measurements, for at least two of salinity, water saturation, cation exchange capacity of the particles, Archie cementation exponent and Archie saturation exponent to characterize the formation, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmitting the at least two to a computing framework for generation of at least one operational parameter for a borehole field operation for the borehole.

### CROSS-REFERENCE TO RELATED APPLICATIONS

This application claims priority to and the benefit of a US Provisional Application having Ser. No. 63/398,690, filed 17 Aug. 2022, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations. In such an example, control may be based at least in part on characteristics of rock where drilling into such rock forms a borehole that can be completed to form a well to produce from a reservoir and/or to inject fluid into a reservoir. While hydrocarbon fluid reservoirs are mentioned as an example, a reservoir that includes water and brine may be assessed, for example, for one or more purposes such as, for example, carbon storage (e.g., sequestration), water production or storage, geothermal production or storage, metallic extraction from brine, etc.

### SUMMARY

A method can include acquiring electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; inverting a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmitting the at least two of salinity, water saturation, cation exchange capacity of the particles, Archie cementation exponent and Archie saturation exponent to a computing framework for generation of at least one operational parameter for a borehole field operation for the borehole.

A system can include a processor; memory accessible to the processor; and processor-executable instructions stored in the memory to instruct the system to: acquire electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; invert a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmit the at least two of salinity, water saturation, cation exchange capacity of the particles, Archie cementation exponent and Archie saturation exponent to a computing framework for generation of at least one operational parameter for a borehole field operation for the borehole.

One or more non-transitory computer-readable storage media can include processor-executable instructions to instruct a computing system to: acquire electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; invert a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmit the at least two of salinity, water saturation, cation exchange capacity of the particles, Archie cementation exponent and Archie saturation exponent to a computing framework for generation of at least one operational parameter for a borehole field operation for the borehole.

Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates an example of a system;

FIG. 3 illustrates an example of a drilling equipment and examples of borehole shapes;

FIG. 4 illustrates an example of a system;

FIG. 5 illustrates an example of a plot and examples of logs;

FIG. 6 illustrates an example of an electromagnetic conductivity tool;

FIG. 7 illustrates an example of a graphical user interface that includes examples of logs;

FIG. 8 illustrates an example of a plot;

FIG. 9 illustrates an example of a plot;

FIG. 10 illustrates examples of plots;

FIG. 11 illustrates an example of a method and an example of a system;

FIG. 12 illustrates examples of computer and network equipment; and

FIG. 13 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

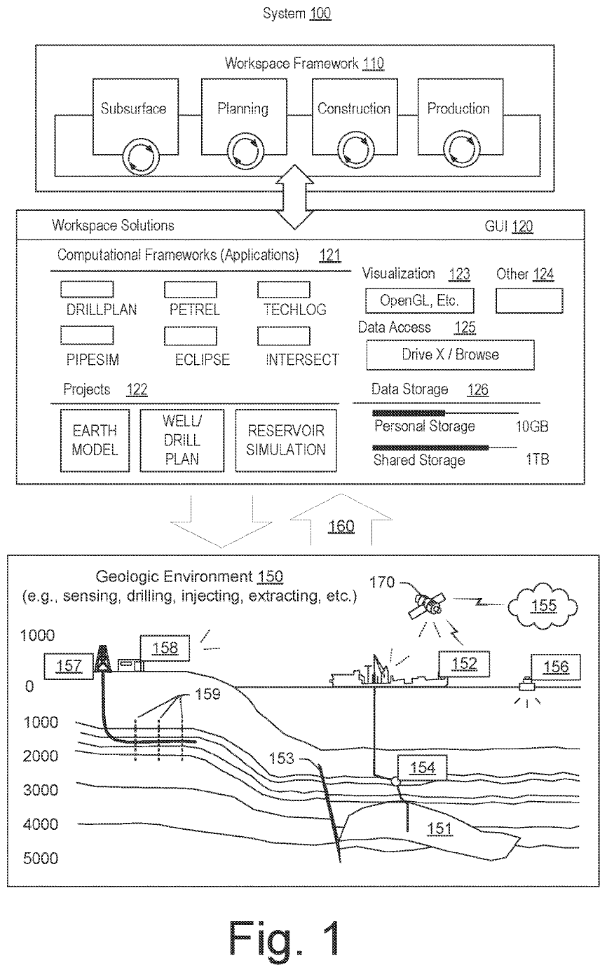

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

While several simulators are illustrated in the example of FIG. 1, one or more other simulators may be utilized, additionally or alternatively. For example, consider the VISAGE geomechanics simulator (SLB, Houston Texas) or the PETROMOD simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

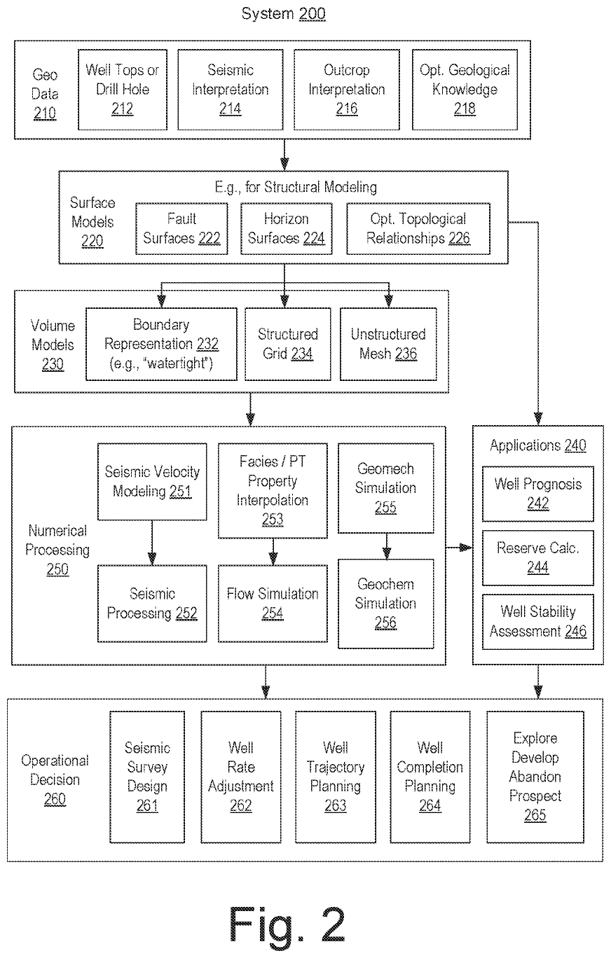

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PIPESIM, ECLIPSE, INTERSECT, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

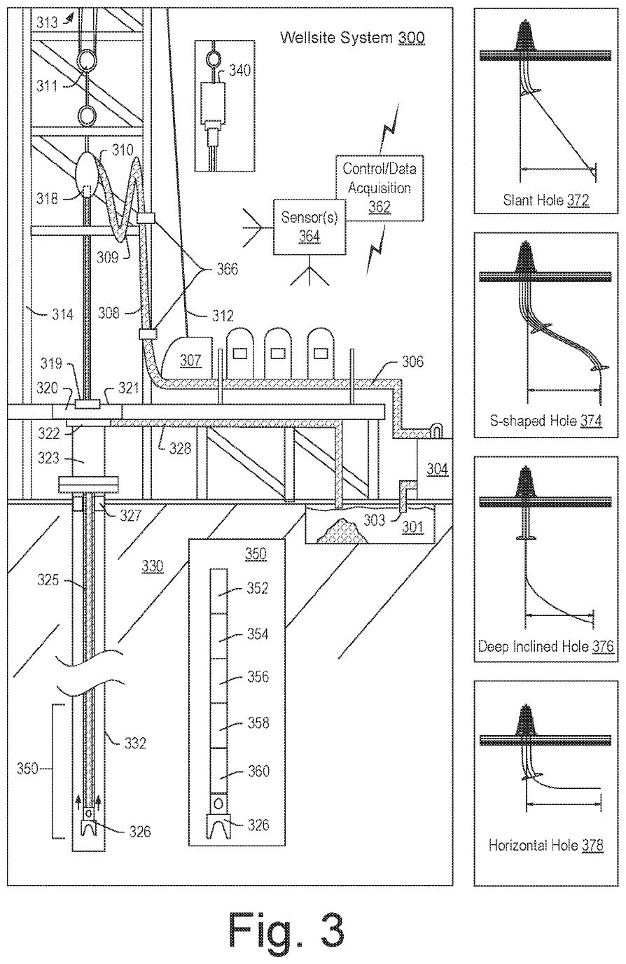

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud may be returned to the mud tank 301, for example, for recirculation with processing to remove cuttings and other material.

In the example of FIG. 3, processed mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry. Characteristics of the mud can be utilized to determine how pulses are transmitted (e.g., pulse shape, energy loss, transmission time, etc.).

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools.

As to a RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

A PDM mud motor may be operated in various modes such as, for example, a rotating mode and a so-called sliding mode, which can be without rotation of a drillstring from the surface. In such an example, a bit RPM can be determined or estimated based on the RPM of the mud motor.

A RSS can drill directionally where there is continuous rotation from surface equipment, which can alleviate the sliding of a steerable motor (e.g., a PDM). A RSS may be deployed when drilling directionally (e.g., deviated, horizontal, or extended-reach wells). A RSS can aim to minimize interaction with a borehole wall, which can help to preserve borehole quality. A RSS can aim to exert a relatively consistent side force akin to stabilizers that rotate with the drillstring or orient the bit in the desired direction while continuously rotating at the same number of rotations per minute as the drillstring.

The LWD module 354 may be housed in a suitable type of drill collar and can contain one or a plurality of selected types of logging tools. It will also be understood that more than one LWD and/or MWD module can be employed, for example, as represented at by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 356 may include equipment for generating electrical power, for example, to power various components of the drillstring 325. As an example, the MWD tool 356 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

A drilling operation can include directional drilling where, for example, at least a portion of a well includes a curved axis. For example, consider a radius that defines curvature where an inclination with regard to the vertical may vary until reaching an angle between approximately 30 degrees and approximately 60 degrees or, for example, an angle to approximately 90 degrees or possibly greater than approximately 90 degrees.

A directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As explained, a system may be a steerable system and may include equipment to perform a method such as geosteering. A steerable system can include equipment on a lower part of a drillstring which, just above a drill bit, a bent sub may be mounted. Above directional drilling equipment, a drillstring can include MWD equipment that provides real time or near real time data of interest (e.g., inclination, direction, pressure, temperature, real weight on the drill bit, torque stress, etc.) and/or LWD equipment. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment to follow a desired route to reach a desired target or targets.

A drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

Geosteering can include intentional directional control of a wellbore based on results of downhole geological logging measurements in a manner that aims to keep a directional wellbore within a desired region, zone (e.g., a pay zone), etc. Geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of approximately one hundred meters from the wellsite system 300.

The system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. Circuitry at the surface may include decoding circuitry to decode encoded information transmitted at least in part via mud-pulse telemetry. Circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

During drilling operations, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. A condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

A sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

A condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings and/or cavings in the annulus.

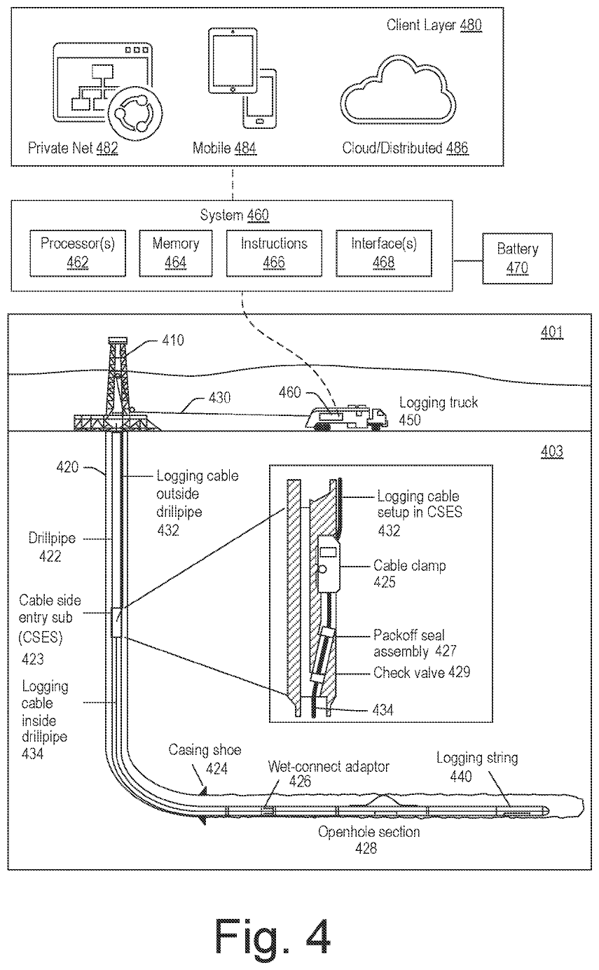

FIG. 4 shows an example of an environment 401 that includes a subterranean portion 403 where a rig 410 is positioned at a surface location above a bore 420. In the example of FIG. 4, various wirelines services equipment can be operated to perform one or more wirelines services including, for example, acquisition of data from one or more positions within the bore 420.

As an example, a wireline tool and/or a wireline service may provide for acquisition of data, analysis of data, data-based determinations, data-based decision making, etc. Some examples of wireline data can include gamma ray (GR), spontaneous potential (SP), caliper (CALI), shallow resistivity (LLS and ILD), deep resistivity (LLD and ILD), density (RHOB), neutron porosity (BPHI or TNPH or NPHI), sonic (DT), photoelectric (PEF), permittivity and conductivity.

As an example, an electromagnetic conductivity measurement tool (ECM tool) can be implemented as a wireline tool and/or implemented as a LWD tool to generate permittivity and conductivity measurements at each frequency for one or more frequencies, which may be interpreted using a petrophysical model. In such an example, output parameters of the model can include water-filled porosity (hence water saturation if the total porosity is known) and water salinity. As an example, textural effects may be output for carbonates or cation exchange capacity (CEC) in various types of rock (e.g., shaly sands, etc.). For a well drilled with oil-base mud (OBM), calculated water salinity can be the formation water salinity. As to CEC, inorganic and/or organic particles can exhibit CEC. Various clays can be characterized by CEC and organic particles with functional groups can be characterized by CEC. For example, kerogen can contribute to CEC in black shales and other rocks. Oxygen functional groups such as carboxyl groups of organic materials can contribute to CEC.

As explained, parameters that can be output using ECM tool measurements (e.g., induction, propagation, etc.) can include bulk formation cation exchange capacity (CEC), water saturation (S_{w}), connate water salinity, Archie cementation exponent and Archie saturation exponent. As an example, a method can provide for simultaneous formation salinity and water saturation determinations using in-phase and quadrature conductivities. As an example, a method can provide for simultaneous determinations as to at least two of formation salinity, water saturation, bulk formation CEC, Archie cementation exponent and Archie saturation exponent, using ECM tool measured in-phase and quadrature conductivities.

The Archie cementation exponent and the Archie saturation exponent can be found in the Archie equation for water saturation where

$${S}_{w}^{n}$$

is equal to R_{w} divided by the product of φ^{m} and Rₜ and where S_{w} is the water saturation of an uninvaded zone, n is the saturation exponent (e.g., which may vary from approximately 1.8 to approximately 4.0), R_{w} is the formation water resistivity at formation temperature, φ is porosity, m is the cementation exponent (e.g., which may vary from approximately 1.7 to approximately 3.0) and Rₜ is the true resistivity of the formation, corrected for invasion, borehole, thin bed, and other effects.

The Archie water saturation equation relates resistivity and fluid saturation. Various equations or models have been developed assuming that shale exists in one of various geometric forms. Such models can include a clean sand term, for example, described by the Archie water saturation equation, plus a shale term. The shale term may be fairly simple or quite complex; the shale term may be relatively independent of, or it may interact with, the clean sand term. Various models tend to reduce to the Archie water saturation equation when the fraction of shale is zero; noting that, for relatively small amounts of shaliness, various models may yield similar results. As to the term “clean sand”, it can be a sand that has no shale or no shaliness and, as to the term “clean formation”, it can be a formation that has no shale or no shaliness; noting that a shale or shaliness threshold value may be utilized, which may be greater than zero (e.g., a low percentage such as, for example, less than 3 percent), to classify a sand or a formation as effectively being “clean”. The term “shaliness” can refer to the content of shale (or clay) in a dominantly non-shale formation; the degree to which ion-exchange processes contribute to resistivity measurements. As an example, electrical conduction in shales can be via an ion-exchange process whereby electrons move between exchange sites on the surface of clay particles. As an example, a threshold value for “clean” (e.g., effectively clean) may be determined based on utilization of data for a formation factor (F) versus formation water resistivity (R_{w}) where, for example, F remains substantially constant with respect to increasing R_{w} for a clean sand and where F decreases with respect to increasing R_{w} for a shaly sand; noting that, in a shaly sand, for lower values of R_{w}, the decrease in F may be less than for higher values of R_{w}. In various instances, a decrease in F at a value of R_{w} can depend on amount or level of shaliness of a shaly sand. As an example, a threshold value for shaliness to classify a formation or a sand as clean may depend on one or more factors (e.g., as may be determined via a plot of F versus R_{w}, etc.).

One type of model is the Dual Water model, which may model shaly formations. The Dual Water model considers two classes of water in pore space: far water, which is the normal formation water; and near water (or clay-bound water) in the electrical double layer near the clay surface. The Dual Water model may be explained with respect to the following three premises: conductivity of clay is because of its CEC; CEC of pure clays is proportional to the specific surface area of the clay; and, in saline solutions, anions are excluded from a layer of water around the surface of the grain where thickness of this layer expands as the salinity of the solution (e.g., below a certain limit) decreases, and the thickness is a function of salinity and temperature. As CEC is proportional to specific area (area per unit weight) and to the volume of water in a counter-ion exclusion layer per unit weight of clay, conductivity of clay tends to be proportional to the volume of the counter-ion exclusion layer, this layer being “bound” to the surface of the clay grains. For clays, this very thin sheet of bound water has relevance because of the large surface areas of clays relative to sand grains (e.g., several magnitudes greater). Therefore, in the Dual Water model, a clay can be modeled as include bound water and clay minerals as components. In such an approach, clay minerals may be modeled as being electrically inert; and the clay electrical conductivity may be modeled as being derived from the conductivity of the bound water, which may be assumed to be independent of clay type. The amount of bound water can vary according to clay type, for example, being higher for finer clays (e.g., with higher surface areas), such as montmorillonite, and lower for coarser clays, such as kaolinite. Salinity also has an effect; in low-salinity waters (e.g., roughly <20,000 ppm NaCl), the diffuse layer expands. In the Dual Water model, porosity and water saturation of a sand (e.g., clean formation) phase (e.g., which may be a nonclay phase) of a formation may be obtained by subtracting the bulk-volume fraction of bound water. The Dual Water model can also include parameters for the Archie saturation exponent and the Archie cementation exponent.

In the example of FIG. 4, the bore 420 includes drillpipe 422, a casing shoe 424, a cable side entry sub (CSES) 423, a wet-connector adaptor 426 and an openhole section 428. As an example, the bore 420 can be a vertical bore or a deviated bore where one or more portions of the bore may be vertical and one or more portions of the bore may be deviated, including substantially horizontal.

In the example of FIG. 4, the CSES 423 includes a cable clamp 425, a packoff seal assembly 427 and a check valve 429. These components can provide for insertion of a logging cable 430 that includes a portion 432 that runs outside the drillpipe 422 to be inserted into the drillpipe 422 such that at least a portion 434 of the logging cable runs inside the drillpipe 422. In the example of FIG. 4, the logging cable 430 runs past the casing shoe 424 and the wet-connect adaptor 426 and into the openhole section 428 to a logging string 440.

As shown in the example of FIG. 4, a logging truck 450 (e.g., a wirelines services vehicle) can deploy the wireline 430 under control of a system 460. As shown in the example of FIG. 4, the system 460 can include one or more processors 462, memory 464 operatively coupled to at least one of the one or more processors 462, instructions 466 that can be, for example, stored in the memory 464, and one or more interfaces 468. As an example, the system 460 can include one or more processor-readable media that include processor-executable instructions executable by at least one of the one or more processors 462 to cause the system 460 to control one or more aspects of equipment of the logging string 440 and/or the logging truck 450. In such an example, the memory 464 can be or include the one or more processor-readable media where the processor-executable instructions can be or include instructions. As an example, a processor-readable medium can be a computer-readable storage medium that is not a signal and that is not a carrier wave.

FIG. 4 also shows a battery 470 that may be operatively coupled to the system 460, for example, to power the system 460. As an example, the battery 470 may be a back-up battery that operates when another power supply is unavailable for powering the system 460 (e.g., via a generator of the wirelines truck 450, a separate generator, a power line, etc.). As an example, the battery 470 may be operatively coupled to a network, which may be a cloud network. As an example, the battery 470 can include smart battery circuitry and may be operatively coupled to one or more pieces of equipment via a SMBus or other type of bus.

As an example, the system 460 can be operatively coupled to a client layer 480. In the example of FIG. 4, the client layer 480 can include features that allow for access and interactions via one or more private networks 482, one or more mobile platforms and/or mobile networks 484 and via the “cloud” 486, which may be considered to include distributed equipment that forms a network such as a network of networks. As an example, the system 460 can include circuitry to establish a plurality of connections (e.g., sessions). As an example, connections may be via one or more types of networks. As an example, connections may be client-server types of connections where the system 460 operates as a server in a client-server architecture. For example, clients may log-in to the system 460 where multiple clients may be handled, optionally simultaneously.

While the example of FIG. 4 shows the system 460 as being associated with the logging truck 450, one or more features of the system 460 may be included in a downhole assembly, which may be a wireline assembly and/or a LWD assembly. In such an approach, various computations may be performed downhole where results thereof may be optionally transmitted to surface (e.g., to the logging truck 450, etc.) using one or more telemetric technologies and/or techniques (e.g., mud-pulse telemetry, wireline, etc.).

As mentioned, a method can provide for simultaneous determination of parameters using ECM tool measurements. For example, a method can simultaneously solve for two of three formation parameters by using in-phase and quadrature conductivity measurements from ECM wireline (WL) and/or ECM logging-while-drilling (LWD) tools. In such an example, unknown formation parameters solved for can be two or more of a group of formation parameters that can include one or more of bulk formation cation exchange capacity (CEC), water saturation (S_{w}), connate water salinity, Archie cementation exponent and Archie saturation exponent. When a sufficient number of such formation parameters is known, which may be via one or more other types of measurements, two of the remaining formation parameters can be simultaneously solved for using two input conductivities. Such a method can apply to one or more types of low frequency electromagnetic measurements that may be affected by interfacial polarization effects from constituents in a formation. Generally, such effects may be seen at frequencies below approximately 400 kHz; noting that a tool or tools may be utilized that generally operates at energy emission frequencies that are greater than approximately 400 kHz.

Various wireline (WL) and logging while drilling (LWD) tools can measure both in-phase and quadrature conductivities. Several minerals create a sufficiently large quadrature signal that may be measured. As an example, a method can include acquiring in-phase and quadrature conductivities for a formation and characterizing particles (e.g., inorganic particles such as clay minerals, organic particles, etc.) in the formation that contribute to the in-phase and quadrature conductivity. In such an example, there can be an implication that a formation lacks other dielectric producing minerals such that particles (e.g., clay minerals, etc.) are present in sufficient quantities to contribute to measurable quadrature conductivity. A WL tool or a LWD tool can include circuitry that provides for acceptable accuracy and precision to measure quadrature conductivity that has been created by particle volumes in a formation.

As an example, solving for formation S_{w} and salinity simultaneously can assist in characterization, operations, etc., particularly when salinity is variable or unknown within the formation and when bulk CEC can be calculated from spectroscopy or other measurements. Formation salinity tends to be unknown such that it becomes a manually determined parameter that is input by a petrophysicist. Using a supplied salinity, S_{w} may then be computed, for example, via shaly sand equations. In cases where a field has been water flooded or where a formation is subject to aquifer recharge, salinity is often unknown and variable in each permeable formation. As mentioned, a method can provide for simultaneously solving for S_{w} and salinity in a manner that allows for a more accurate S_{w} calculation. As an example, a method may be applied to instances where salinity is known such that S_{w} and CEC can be solved for simultaneously. As an example, in instances where S_{w} is known, a method can include solving for CEC and salinity simultaneously.

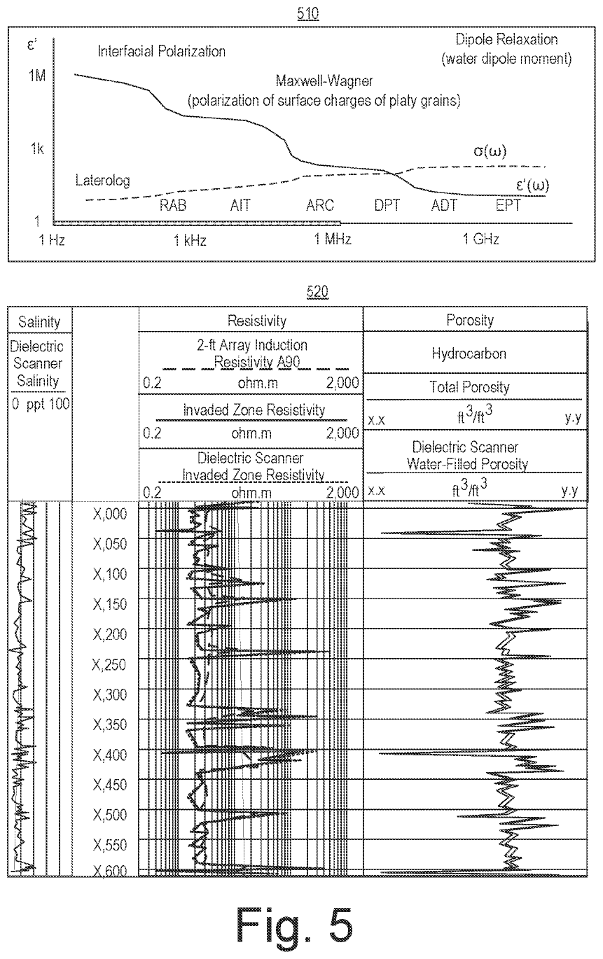

FIG. 5 shows an example of a plot 510 of permittivity versus frequency and an example of logs 520 from a dielectric scanner tool; noting that an ECM tool can operate at frequencies that are less than those of a dielectric scanner tool. In the plot 510, various frequency dependent physical phenomena are shown along with conductivity (a) and dielectric constant (ε′). Tool acronyms are also shown, including laterolog operational at 35 Hz and 280 Hz, resistivity at bit (RAB) operational at 1.5 kHz, array induction tool (AIT) operational at 26 kHz and 52 kHz, compensated array resistivity (ARC) operational at 0.4 MHz and 2 MHz, dielectric propagation tool (DPT) operational at 25 MHz, array dielectric tool (ADT) operational at 0.9 GHz and electromagnetic propagation tool (EPT) operational at 1.1 GHz. In the plot 510, various frequencies can be approximate, noting that a particular tool (e.g., laterolog, RAB, AIT, ARC, DPT, ADT, EPT, etc.) may operate at a narrower range, a greater range, etc., than the frequencies listed or appearing in the plot 510. In terms of frequency, an approximate frequency value may be plus or minus fifteen percent a stated frequency value. For example, approximately 100 kHz may be 85 kHz to 115 kHz. Again, the plot 510 shows relative effects of frequency on measured conductivities and dielectric constants for earth formations. Various underlying physics responsible for the effects are indicated. As explained, one or more tools may operate at a number of frequencies, for example, ADT frequencies can include 24, 100, 350, 960 MHz; whereas, an ECM tool (e.g., consider an AIT) can operate at various frequencies that are less than ADT frequencies.

As an example, a dielectric scanner tool (e.g., ADT), as a wireline tool and/or as a drilling tool, can include a relatively short, multispacing antenna array pad. In such an example, each cross-dipole antenna can be collocated with magnetic dipoles. As an example, transmitters (e.g., TA and TB) can be located centrally while receivers (e.g., RA1-4 and RB1-4) can be placed symmetrically around the transmitters for improved measurement accuracy and borehole compensation. To minimize environmental effects, a short, fully articulated antenna pad can be applied firmly against a borehole wall, for example, by a hydraulically operated eccentering caliper to enable appropriate pad contact, even in rugose boreholes. During operation, electromagnetic waves can be generated and propagated into the formation at multiple frequencies (e.g., consider four frequencies) with multiple polarizations (e.g., consider two polarizations) to promote high-resolution, high-accuracy measurements of reservoir properties at a distance into the formation, which may be, for example, up to approximately 10 cm (e.g., 4 inches) in from a borehole wall.

As shown in the plot 510, a laterolog tool can operate at the lower end of the electromagnetic frequency spectrum. A laterolog is a type of resistivity log as acquired by a laterolog tool that can use guard or bucking electrodes that aim to force current to flow nearly at right angles to the laterolog tool. For example, a laterolog tool can provide current that can be fed into bucking electrodes where sensing electrodes can be used to adjust bucking-electrode currents. A dual laterolog tool may measure resistivity at different depths of penetration. An array laterolog tool can determine resistivities by processing data from an array of detectors rather than by focusing current.

As shown in the plot 510, an EPT can operate at the higher end of the electromagnetic frequency spectrum. An EPT can provide for measurement using a high operational frequency (e.g., approximately 1 GHz) to determine dielectric properties of a formation. For example, consider an EPT that includes a GHz microwave transmitter that can be positioned a distance below two receivers separated by approximately 4 cm. At approximately 1 GHz, the response can be explained as the propagation of a wave. Thus, the phase shift and attenuation of the wave between the receivers can be measured and transformed to give log measurements of propagation time and attenuation. Because of the short spacings, an EPT produces exceptional vertical resolution and can generally be utilized within centimeters of a borehole wall (e.g., depending on resistivity). Different transmitter and receiver spacings and orientations can be used, leading to different arrays, such as an endfire array and a broadside array. An ideal measurement would give the plane wave properties of the formation. However, the geometry of the measurement tends to preclude this such that a spreading-loss correction is employed for the attenuation and to a smaller extent for the propagation time. EPT measurements can also be affected by dielectric properties and thickness of mudcake; noting that borehole compensation can adjust for EPT tilt or a rough borehole wall.

As to the DPT, in the plot 510, it is shown as associated with frequencies above 1 MHz and less than 1 GHz. In terms of tool notation, “dielectric propagation” as in DPT differs from “electromagnetic propagation” as in EPT, while both utilize electromagnetic energy. As to DPT measurements, they can refer to logs that measure the properties of electromagnetic waves as they move through a formation. For example, propagation resistivity logs may be between approximately 100 kHz and 10 MHz and other propagation logs may be between 20 and 200 MHz. As explained, logs at frequencies above 200 MHz and into the GHz range are referred to as electromagnetic propagation logs as acquired from an EPT. Below approximately 100 kHz, various types of measurements can be based on properties of standing waves, rather than propagation. Induction and laterolog tools can operate in ranges that include electromagnetic frequencies at or below 100 kHz.

As an example, an induction tool (e.g., AIT), as a type of ECM tool, can include multiple coil arrays that aim to optimize vertical resolution and depth of investigation. As to operation of an induction tool, a receiver coil and a transmission coil can be operatively coupled to circuitry for operation at one or more frequencies. As an example, coils can be mounted coaxially on a mandrel. As an example, a coil separation may be in a range from approximately 30 cm (e.g., 1 ft) to approximately 300 cm (e.g., 10 ft). As an example, a coil can be defined by a number of turns, for example, a coil can have from approximately several turns to approximately 100 turns or more. As to operating frequency or frequencies, a tool may operate at relatively discrete frequencies in a range from approximately tens of kHz to hundreds of kHz.

In the example of FIG. 5, in the logs 520, a log of salinity with respect to depth is shown along with logs of resistivity and porosity with respect to depth where the resistivity log shows array induction resistivity (2 ft, A90), invaded zone resistivity and dielectric scanner invaded zone resistivity and where the porosity log includes total porosity and dielectric scanner water-filled porosity, and optionally hydrocarbons (e.g., based at least in part on water-filled porosity). In the logs 520, various tracks rely on ADT measurements, which, as explained per the plot 510, are acquired at a higher frequency or frequencies than AIT measurements.

As explained, a method can utilize ECM tool measurements for simultaneous generation of output of two or more of salinity, water saturation, CEC, Archie cementation exponent and Archie saturation exponent. Such a method can be performed without use of an ADT or ADT measurements; noting that, for one or more reasons, an ADT and ADT measurements may be utilized when characterizing a formation, performing a portion of a method, etc.

Referring again to the plot 510, it shows various mechanisms responsible for the effects of formation conductivity and dielectric as a function of frequency. As an example, a method can include acquiring measurements from a tool or tools that can operate using one or more frequencies in a range such as, for example, a range of frequencies from DC to 100 kHz or even to 2 MHz where interfacial polarization (IPol) effects tend to dominate. In various examples, frequencies may be below 2 MHz and in some instances below 100 kHz. As indicated in the plot 510, above approximately 2 MHz, Maxwell-Wagner surface charge effects start to dominate. As an example, a method can include using the Misra model to predict IPol effects, which can occur at frequencies in the MHz range that tend to be diminished compared to the response at the lower frequencies. At higher frequencies (e.g., ~100 kHz to 2 MHz) and above, a Maxwell-Wagner model may be more appropriate especially from 2 MHz to several hundred MHz (e.g., approximately 300 MHz). As an example, a method may include acquiring measurements at frequencies higher than in an IPol range and extrapolating a fitting function and/or a model down to a value or values that would have been measured at a lower frequency where IPol effects dominate.

In various examples, modeling can pertain to lower frequencies where IPol effects can be expected to be the dominate mechanism affecting conductivity and dielectric measurements. For ranges where Maxwell-Gardner effects dominate, one or more models may be selected and utilized that account for conductivity and dielectric. Imaginary conductivity and dielectric are related quantities, and these terms can be used interchangeably.

$${ε}_{r}^{′} = \frac{{σ}_{imag}}{{ωε}_{0}}$$

In the foregoing equation, ε′ᵣ is the dielectric constant, σ_{imag} is the imaginary conductivity, co is the frequency and ε₀ is the permittivity of free space or a vacuum.

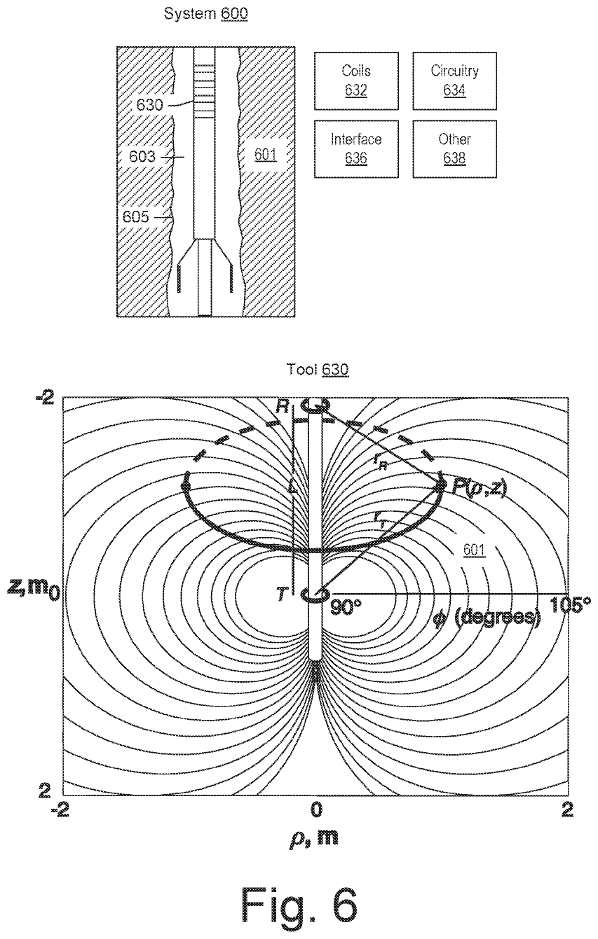

FIG. 6 shows an example of a system 600 with respect to a formation 601 with a borehole 603 defined in part by a borehole wall 605 where the system 600 includes a tool 630 that includes coils 632, circuitry 634 operatively coupled to the coils 632, one or more interfaces 636 (e.g., signal, power, etc.) and one or more other features 638. As an example, the tool 630 can be an ECM tool and can include various features of an ECM tool such as, for example, an array induction imager tool (e.g., AIT tool, SLB, Houston, Texas) and/or a triaxial induction tool (e.g., RT SCANNER tool, SLB, Houston, Texas). As explained with respect to the plot 510 of FIG. 5, tools can include various configurations of electrodes, etc., which can be utilized for emissions and receptions to make measurements.

As an example, an ECM tool can include multiple coil arrays that aim to optimize vertical resolution and depth of investigation. As to operation of an ECM tool, consider a graphical illustration of the tool 630 in FIG. 6, which shows two coils, labeled R and T, which represent a receiver coil and a transmission coil, respectively, which are operatively coupled to circuitry.

As shown, the coils can be mounted coaxially on a mandrel. As an example, a coil separation may be in a range from approximately 30 cm (e.g., 1 ft) to approximately 300 cm (e.g., 10 ft). As an example, a coil can be defined by a number of turns, for example, a coil can have from approximately several turns to approximately 100 turns or more. As to operating frequency or frequencies, a tool may operate at relatively discrete frequencies in a range from approximately DC to tens of kHz to hundreds of kHz or more.

FIG. 6 shows the tool 630 with respect to the formation 601 where the two-coil induction array (R, T) can induce distributed currents in the formation via emissions of the transmitter coil. In the examples of FIG. 6, the borehole 603 can be assumed to be filled with fluid (e.g., liquid or gas) or fluids (e.g., liquid and gas), which may include solids. As an example, the borehole 603 can include drilling fluid (e.g., drilling mud).

In the example of FIG. 6, the induction transmitter coil (T) can be driven by an alternating current of circuitry (e.g., the circuitry 634 as operatively coupled to a power source) to create a primary time varying magnetic field around the transmitter coil. The primary time varying magnetic field can cause eddy currents to form, which may be in a relatively continuous circular distribution centered around an axis of the borehole. The induced eddy currents can be substantially proportional to conductivity of the formation and generate a secondary time varying magnetic field that can be detected via the receiver coil (R), for example, the secondary time varying magnetic field of the eddy currents can induce an alternating voltage in the receiver coil (R). As an example, the induced alternating voltage amplitude can be first-order proportional to the conductivity of the formation.

Where the transmitter coil (T) current is alternating, there can be a phase shift between the transmitter current and the current density in the formation. The phase shift can differ in the formation, for example, it can increase with distance into the formation, as represented by the number of degrees φ in FIG. 6. The phase in the receiver coil (R) can be even further shifted. At relatively low conductivities, the total phase shift is approximately 180 degrees and increases with increasing formation conductivity.

As an example, an electromagnetic conductivity tool may measure the part of the voltage that is 180 degrees phase-shifted from the transmitter current (e.g., so-called R-signal). As conductivity increases, and phase shifted, voltage can be a bit less than expected from a linear relationship. The difference can be attributed to a skin effect and/or dielectric permittivity. The dielectric permittivity ε=εᵣε₀ includes the relative permittivity er without units and the absolute dielectric permittivity of a vacuum ε₀. As an example, an electromagnetic conductivity tool can make one or more additional measurements, for example, at a phase shift of approximately 270 degrees from the transmitter current (e.g., so-called X-signal). As an example, the R-signal and X-signal measurements can be in quadrature and allow for precise phase and amplitude measurement of the receiver voltage induced in the receiver coil (R).

To produce adequate sensitivity to an uninvaded zone, an electromagnetic conductivity tool may perforce include signals from a large volume of formation. A challenge can be to determine precisely where a measurement is coming from in a formation. As an example, a geometrical factor, as a 2D function g(ρ,z), can define the part of the total signal that comes from an infinitesimally thin loop around a borehole. Such an approach tends to be valid at very low conductivities; noting that one or more modifications of the geometrical factor may be made for validity in low contrast formations at various conductivities (e.g., consider the Born response).

As an example, a response to formation layers can be given by a vertical response function gV(z), which can be defined as the integral of the 2D response function g(ρ,z) over radius ρ. As an example, a response to radial variations in a thick bed can be given by the radial response function gR(ρ), which can be defined as the integral of g(ρ,z) over z. The response of an array to invasion in a thick bed can be characterized by an integrated radial response, which can be the cumulative integral of gR(ρ) over radius.

As direct transmitter-receiver mutual coupling of a two-coil array can produce a voltage several thousand times that from a formation, a two-coil array may be less practical than a tool with more coils. For example, consider a practical array that includes a three-coil array with a transmitter and two receivers. In such an example, the second receiver can be positioned axially between the transmitter and main receiver and may be wound oppositely so that the voltages in the two receivers tend to cancel when the array is in free space. In such an example, the response can be determined as a sum of the coil-pair responses.

As an example, an electromagnetic conductivity tool can include three transmitters and three receivers, with a symmetric Born response g. Such an array can be designed to achieve deep investigation, reasonable vertical resolution, and a low borehole effect. However, large peaks in the 2D response along the tool may result in sensitivity to borehole washouts, called cave effect.

As an example, an electromagnetic conductivity tool can be a dual-induction tool, which can measure or discriminate resistivity in multiple zones, which can include an invaded zone and a virgin zone. For example, consider a tool with an array as a deep-induction measurement array with a set of receivers that works with transmitters to produce a shallower measurement.

As to a multi-zone electromagnetic conductivity tool, measurements (e.g., such as ILm and ILd measurements) may not respond linearly to formation conductivity. Such nonlinearity can be closely related to changes in response shape and depth of investigation with increasing conductivity. The nonlinear response of an electromagnetic conductivity array can be referred to as a skin effect because it is related to the skin depth effect of AC current flowing in conductors, which can be frequency dependent. For example, as frequency increases, the skin depth can decrease; whereas, skin depth can increase as frequency decreases (e.g., long wavelengths).

As an example, a function can be applied to tool voltages to adjust for nonlinearity. For example, consider processing that effectuates a skin-effect function (“boost”) applied to the measured R-signals from electromagnetic conductivity arrays. For example, consider computations based on response in an infinite homogeneous medium. As an example, ILd measurements can be processed using a three-station deconvolution filter to slightly sharpen bed-boundary transition(s) and to adjust for shoulder effect over a particular resistivity range (e.g., 1 to 10 ohm·m). As an example, at one or more other formation-resistivity ranges, the response may either produce horns or large shoulder effects.

As an example, an electromagnetic conductivity tool can be a phasor induction tool that can implement environmental adjustments. For example, consider use of a linear deconvolution function to adjust for shoulder effect and use of X-signal measurements to adjust for skin effect. As an example, an electromagnetic conductivity tool can implement phasor processing, for example, where it can be shown that a filter fitted at low conductivity works well at low conductivity but produces large errors at high conductivity. In such an example, the error is, however, a slowly varying function closely related to the X-signal. An algorithm applied to the X-signal to match it to the skin-effect error can allow a single FIR filter to adjust for shoulder effect over a relatively wide range of conductivities. As an example, one or more types of deconvolution filters may be utilized, which may provide for electromagnetic conductivity logs with a 2 ft (e.g., 0.6 m) vertical resolution (compared with 5 ft for ILm and 8 ft for ILd; 1.5 m for ILm and 2.4 m for ILd).

As an example, an electromagnetic conductivity tool can be a dual-induction tool that can measure both R and X signals and apply automatic shoulder-effect adjustments. As an example, a tool may provide a vertical resolution of approximately 2 ft (e.g., 0.6 m) and a median depth of investigation of approximately 90 in (e.g., 2.29 m).

As to an array electromagnetic conductivity tool, it may provide for results that are improved in some manners with respect to a phasor induction tool (e.g., dual-induction approach). An array electromagnetic conductivity tool may provide better estimates of Rt in the presence of deep-invasion or complex transition zones. As an example, a tool may include an oil-based mud imaging tool (e.g., OBM tool).

As an example, a tool can include several electromagnetic conductivity arrays with different depths of investigation. For example, consider an ECM tool as including eight three-coil arrays ranging in length from approximately 6 inches to approximately 6 ft (e.g., approximately 0.15 m to approximately 1.83 m).

As to array electromagnetic conductivity, a tool can process raw array signals for borehole effects. For example, consider a process based on a forward model of the arrays in a circular borehole, which may include a description of the tool in the model.

As an example, a signal measured by an electromagnetic conductivity tool eccentered in a borehole can be described mathematically as a function of four parameters: the borehole radius r, the mud conductivity am, the formation conductivity a, and the tool position x with respect to the borehole wall (commonly referred to as the “standoff”).

As an example, an adjustment algorithm can solve for some of these parameters by minimizing the difference between the modeled and actual logs from the four shortest arrays. The information content of these measurements is not sufficient to solve for the four borehole parameters at the same time. In practice, two of the four parameters can be reliably determined by this method. The other two parameters have to be either measured or fixed. The equivalent homogeneous formation conductivity 6f is to be solved for because no measurement is closely enough related to it. This leaves one of the other parameters to be determined, and the remaining two parameters to be entered as measurements. This leads to the three borehole adjustment methods to compute mud resistivity, hole diameter, and standoff. A tool can include mud resistivity sensors and circuitry to compute standoff, which may be utilized as a default borehole-adjustment method in water-based mud (WBM).

As an example, an equation can associate a combination of logs from an eight array that distils radial information from the eight arrays into five independent logs with depths of investigation of 10, 20, 30, 60, and 90 in (0.254, 0.51, 0.76, 1.52, and 2.29 m). In such an example, each of these five logs may be available at a resolution of 1, 2, and 4 ft (e.g., 0.3, 0.6 and 1.2 m). In such an example, the radial profile tends to be the same at the resolutions, and the vertical resolution tends to be the same for the radial depths.

Interpretation of logs in deviated wells or where the apparent dip tends to be relatively high can be considerably complicated. Users of induction logs may take care in making quantitative analyses in wells that are deviated, or if the formation is dipping. If the shoulder-bed contrast is 20 or less, then the minimum angle where dip adjustment is demanded can be approximately 30 degrees. At shoulder-bed contrast of over 100, the logs adjustments can be demanded at dips as low as 10 degrees.

As an example, a tool can include circuitry that can measure one or more physical phenomena. As an example, consider circuitry that can measure electromagnetic conductivity. For example, consider a tool such as an array electromagnetic conductivity imager tool or a triaxial electromagnetic conductivity tool, which can acquire array electromagnetic conductivity imager tool measurements. As an example, a tool can output values (e.g., values based on sensor measurements) for one or more resistivities. For example, consider vertical resistivity Rv and horizontal resistivity Rh. As an example, a tool can include a number of arrays such as, for example, consider a number of triaxial arrays where each array includes three collocated coils that can perform measurements of a formation. As an example, Rv and Rh can be calculated at each triaxial spacing. As an example, a tool can include a number of single-axis receivers that can help to characterize a borehole signal and process such a signal or signals for improved triaxial measurements. As an example, a tool can include circuitry for calculating formation dip and/or azimuth, for example, to assist with structural interpretation.

As an example, in a laminated formation, there can be resistivity anisotropy where, for example, resistivity measured perpendicular to laminated bedding (Rv) tends to be higher than resistivity measured parallel to the bedding (Rh). Such a scenario can occur when high resistivity sand layers are interspersed with low resistivity shale layers. As mentioned, an ECM tool can include components that can measure Rv and Rh. As an example, a method can include using vertical and/or horizontal components of in-phase conductivity and may include solving for horizontal and/or vertical quadrature conductivities, for example, using the tri-axial induction or propagation measurements. Various techniques described with respect to horizontal conductivities may be applied to vertical conductivities.

As an example, a method can be implemented for a sufficiently low frequency with knowledge that the dielectric of a low clay clean sand can be zero or sufficiently close to zero, regardless of salinity. In other words, such an approach can assume that, if there is no clay (e.g., or a quite low level of clay), salinity does not have an impact when it comes to the value of the dielectric at a sufficiently low frequency. As an example, such an approach can be implemented in a method that can involve solving for one of three unknowns rather than two of three unknowns where, for example, an assumption may be made as to values of the other two unknowns such that the method can solve for the remaining one of the three unknowns. For example, consider a method that can improve geosteering of a drill bit in a formation where the method can provide for distinguishing between a wet sand and a shale; noting that such a method may be utilized for one or more other purposes (e.g., additionally or alternatively). In such an example, consider a scenario where it is possible to assume that water saturation is sufficiently high, such as, for example, 100 percent (e.g., a shale or a clean wet formation), and then solving for CEC for an approximate known salinity (e.g., an assumed salinity, etc.).

As an example, a method may implement a flag that provides for the dielectric of a low clay clean sand to be set to a sufficiently low value (e.g., zero or other low value) regardless of salinity where measurement frequency is at a sufficiently low frequency, which may be in accordance with a low frequency threshold. In such an example, a low clay formation may be flagged in accordance with a low clay threshold and, for example, a water saturation threshold may be utilized (e.g., approximately 85 percent) to make an assumption as to the value of water saturation being sufficiently high (e.g., to set it to 100 percent, etc.).

As an example, where a formation includes a shale formation or a clean wet formation, a method may consider setting water saturation to 100 percent or a sufficiently high percentage (e.g., 85 percent or more). In such an example, an estimated amount of clay of particles of the formation may be less than a minimum threshold value to consider the formation to be “low clay” or effectively “clay free”. For example, consider a minimum threshold value of approximately 3 percent or less where, below that value, a formation may be considered to be “low clay” or “clay free” for one or more purposes. As explained, such an approach can be based on knowledge that the dielectric of a low clay clean sand can be zero or sufficiently close to zero, regardless of salinity. As explained, such an approach can provide for solving for one of three unknowns, where evidence-based assumptions are made for the other two unknowns (e.g., evidence sufficient to conclude that a formation is relatively “clay free” and that water saturation is sufficiently high). As mentioned, such an approach can provide for distinguishing between a wet sand and a shale, which may, for example, provide guidance for geosteering in a relatively thin reservoir layer and/or one or more other applications (e.g., field operations, etc.).

Developments in electromagnetic conductivity tools can provide accurate measurements of in-phase and quadrature signals. In various instances, a quadrature signal can be used to provide a skin-effect adjustment to the in-phase signal. Electromagnetic conductivity-tool processing and interpretation tends to neglect dielectric effects. In contrast, in various examples, such effects are not neglected; rather, dielectric effects can be utilized in electromagnetic conductivity-tool processing. For example, consider one or more inversion algorithms that can be used to determine a dielectric permittivity and electric conductivity from the in-phase and quadrature signals simultaneously. As an example, consider one or more inversion algorithms of a US Patent Application having publication number 2009/0248308 A1, published 1 Oct. 2009, to Luling, is incorporated by reference herein, which is entitled “Simultaneous inversion of induction data for dielectric permittivity and electrical conductivity” ('308 application). The dielectric permittivity has been shown to be large on the order of 10,000 to 100,000,000 when certain clays and metallic particles are present in the formation of the right size, shape and percent volume. For example, consider a US Patent Application having publication number 2016/0139293 A1, published 19 May 2016, to Misra, which is entitled “Subsurface Estimation of Level of Organic Maturity” and incorporated by reference herein ('293 application); and, for example, consider a US Patent Application having publication number 2018/0113088 A1, published 26 Apr. 2018, to Misra, which is entitled “Method to estimate water saturation in electromagnetic measurements” and incorporated by reference herein ('088 application).

As to additional descriptions of materials in matrixes, consider Misra et al., Interfacial polarization of disseminated conductive minerals in absence of redox-active species: Part 1: Mechanistic model and validation, Geophysics, March 2016, Vol. 81, No. 2, pp. E139-E157 (“Misra Part 1”); Misra et al., Interfacial polarization of disseminated conductive minerals in absence of redox-active species: Part 2: Effective electrical conductivity and dielectric permittivity, Geophysics, March 2016, Vol. 81, No. 2, pp. E159-E176 (“Misra Part 2”); Misra et al., Dielectric Effects in Pyrite-Rich Clays on Multi-frequency Induction Logs and Equivalent Laboratory Core Measurements, SPWLA-2016-Z, SPWLA 57th Annual Logging Symposium, 25-29 June, Reykjavik, Iceland, 2016 (“Misra 2016”); and Misra et al., Laboratory Investigation of Petrophysical Applications of Multi-Frequency Inductive-Complex Conductivity Tensor Measurements, IDSPWLA-2015-Y, SPWLA 56th Annual Logging Symposium, 18-22 July, Long Beach, California, USA, 2015 (“Misra 2015”), each of which is incorporated by reference herein.

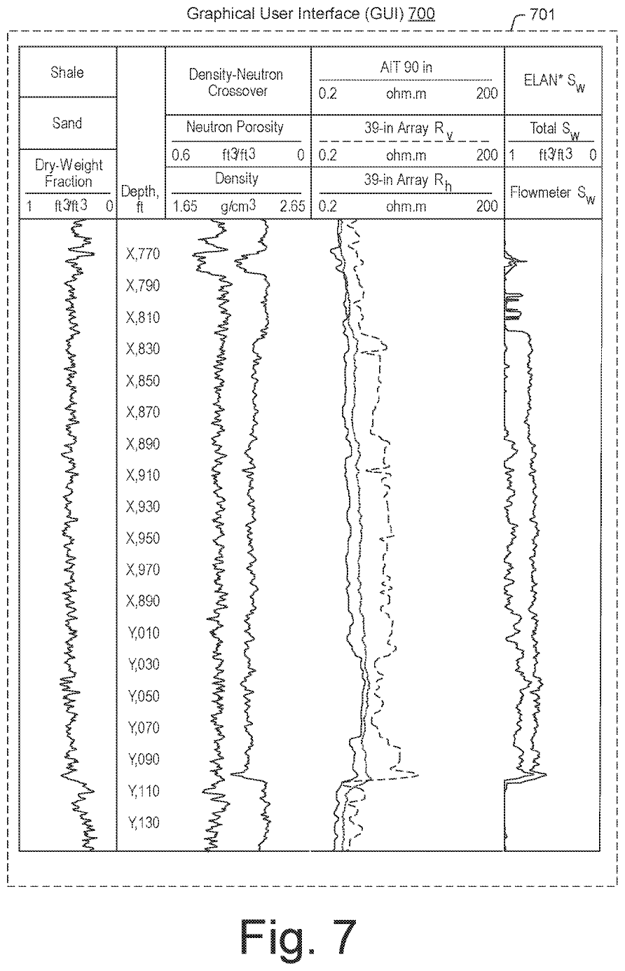

FIG. 7 shows an example of a graphical user interface (GUI) 700 that includes a series of logs rendered to a display 701 (e.g., a display operatively coupled to a system such as the system 460 of FIG. 4). The GUI 700 includes logs for shale and sand as dry-weight fraction (e.g., from 1 to 0), neutron, AIT, Rv, Rh and flow related information. As to the AIT, it is given for an investigation depth of 90 inches (e.g., 2.29 m) and the Rv and Rh are given for a 39 inch (e.g., 0.99 m) array. As can be seen, the values for Rv tend to exceed those for Rh. As mentioned, resistivity measured perpendicular to laminated bedding (Rv) tend to be higher than resistivity measured parallel to the bedding (Rh). As mentioned, such a scenario can occur when high resistivity sand layers are interspersed with low resistivity shale layers. As an example, a method can include solving for quadrature vertical and horizontal conductivities and utilizing such conductivities for one or more purposes, which can include to perform one or more inversions as to one or more formation parameters.

As explained, ADT and AIT measurements differ as to their frequency ranges and hence differ as to at least some of underlying physical phenomena as explained with respect to the plot 510 of FIG. 5. As mentioned, a method can include using electromagnetic conductivity measurements to determine, simultaneously, two or more of salinity, water saturation, CEC, Archie cementation exponent and Archie saturation exponent.

As mentioned, a method can include assuming values for two unknowns and solving for a third unknown. For example, values for salinity and water saturation may be assumed to solve for a value for CEC. In such an example, one or more assumptions may be made in a manner that depend on knowledge that, at a sufficiently low frequency, the dielectric of a low clay clean sand can be sufficiently close to zero regardless of salinity.

As to an in-phase conductivity petrophysical formulation, the in-phase measured conductivity can be modeled in terms of the formation petrophysical properties using the Dual Water saturation equation:

$${σ}_{t} = {ϕ}^{m} {S}_{w}^{n} {σ}_{we} \qquad eq . 1$$

where

$${S}_{w}^{n}$$

is the water saturation raised to the power of n, φ^{m} is the porosity raised to the power of m, and σ_{we} is the equivalent water conductivity; n is the saturation exponent (e.g., Archie saturation exponent) which is a function of the formation wettability and is usually left at the default value of 2; m is the cementation component (e.g., Archie cementation exponent) which is computed as a function of shaliness or left at the default value of 2 in shaly sands and where σ_{we} can be computed as:

$${σ}_{we} = {σ}_{w ( T , S )} + \frac{( {σ}_{bw ( T , S )} - {σ}_{w ( T , S )} ) α {V}_{qH ( T , S )} * {Q}_{v}}{{S}_{w}^{n}} \qquad eq . 2$$

where σ_{w(T,S)} is the connate water conductivity which is a function of the temperature (T) and connate water salinity (S), the bound water or clay water conductivity (σ_{bw(T,S)}), is a function of temperature and salinity, αV_{qH(T,S)} is the specific clay water volume factor which is a function of temperature and salinity, Qᵥ is the clay charge concentration per unit volume which is a function of the bulk formation CEC, and S_{w} is the water saturation.

In the foregoing example formulation, eq. 2 can be substituted into eq. 1 to solve for S_{w}.

As to parameter selection, CEC and Qᵥ are not two independent parameters. CEC may be computed from eq. 3 where ρ_{g} is the grain density (e.g., dry rock density, which can include inorganic material and/or organic material):

$$CEC = 100 * \frac{{Q}_{v}}{{ρ}_{g}} * \frac{ϕ}{( 1 - ϕ )} \qquad eq . 3$$

In eq. 3, porosity, φ^{m}, can be input from one or more other measurements such as nuclear measurements and therefore considered a known input. Temperature may be measured by using one or more logging instruments that may also be measuring formation conductivity or, for example, temperature may be known from lab experiments. A parameter σ_{bw(T,S)} can be calculated from the following equation:

$${σ}_{bw ( T , S )} = \frac{{β}_{dw ( T )}}{α {V}_{qH ( T , S )}} \qquad eq . 4$$

where β_{dw} is a constant which is a function of temperature only.

As to connate water salinity and conductivity, these are functions of each other, where a conversion formula can be:

$$\frac{1}{{σ}_{w \_ 75}} = {R}_{w \_ 75} = 0.0123 + \frac{3647.5}{{S}^{\text{.955}}} \qquad eq . 5$$

As to water electrical conductivity, σ_{w} at another temperature, it may be determined from charts or the Arp's formula:

$${σ}_{w ( T )} = {σ}_{w \_ 75} ( \frac{RTW + 6.77}{75 + 6.77} ) \qquad eq . 6$$

where RWT is the temperature for σ_{w}(T) in deg F.

The formation parameters of CEC or Qᵥ, and connate water conductivity, σ_{w}, or salinity can then be the remaining parameters for computing

$${S}_{w}^{n} ,$$

from the measured conductivity, σₜ using eqs. 1 and 2.

Having four unknowns and one measurement demands knowledge of temperature (T), porosity (φ), Qᵥ and connate water conductivity (σ_{w}) to compute saturation (S_{w}), from the measured conductivity (σₜ) using eqs. 1 to 6. As mentioned above, temperature (T) may be measured or otherwise determined thereby leaving three unknowns.

As an example, a method can include application of a Dual Water formulation to lab data. An article by Vinegar et al., Induced Polarization of Shaly Sands, Geophysics, 49, 1267-1287 (1984) is incorporated by reference herein, referred to as Vinegar (1984). Vinegar (1984) provides measurements of both in-phase and quadrature conductivities at room temperature for four core samples for five connate water salinities.

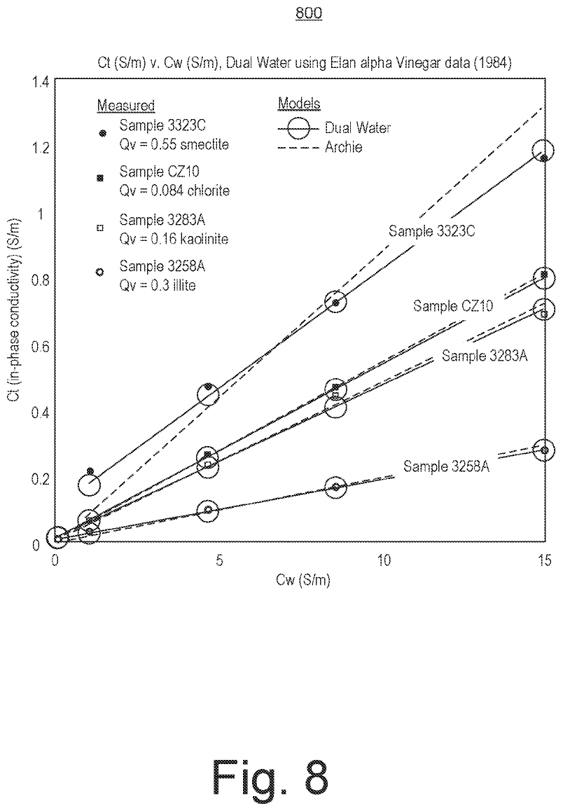

FIG. 8 shows an example plot 800 of the in-phase conductivities (Cₜ) as a function of connate water conductivity (C_{w}) and the Dual Water (DW) forward model using eqs. 1 to 6. In such an approach, the parameters for the equations are known or calculated from lab measurements. In the plot 800, the Dual Water model for each core sample is shown using circles connected with solid lines, the Archie formulation are shown using dotted lines, and the lab measurements are represented as points. As indicated, the Dual Water model replicates the measured conductivities reasonably well and much better than the Archie formulation for an entire range of water conductivity (C_{w}). As an example, a water saturation estimation in shale may be largely dependent on its organic content (e.g., kerogen) and inorganic components (e.g., minerals). In various instances, the Archie formulation may be suitable for a water saturation calculation in a clean reservoir, noting that an Archie equation for clean formations may include a tortuosity factor (e.g., denoted “a”), which, if unity (i.e., one), may result in the aforementioned Archie equation for water saturation where

$${S}_{w}^{n}$$

is equal to R_{w} divided by the product of φ^{m} and Rₜ; noting, however, that the Archie equation may be unsuitable for various shaly formations. For example, a determination of water saturation by electrical measurement may be based on the Archie equation in a clean formation, while in a shaly formation, a more complex approach may be utilized. As an example, accurate determinations of water saturations in a clean and in a shaly formation can demand reliable values of the Archie parameters: a (e.g., if not set to 1), m and n. As explained, a model may be based at least in part on a function between formation conductivity and conductivity of fluids in pore spaces of a reservoir (e.g., reservoir rock, reservoir formation, etc.).

As to a quadrature conductivity petrophysical formulation, to demonstrate how a method can determine, for example, two of a group of five parameters simultaneously, consider the core sample 3258A quadrature conductivity lab measurements as presented in Vinegar (1984).

An article Revil, A., Spectral induced polarization of shaly sands: Influence of the electrical double layer, Water Resources Research, 48, W02517 (2012), doi:10.1029/2011WR011260, is incorporated herein by reference, referred to as Revil (2012). In Revil (2012), a formulation exists for quadrature conductivity in terms of petrophysical parameters of water saturation (S_{w}), and bulk formation CEC. The Revil (2012) formulation for the measured quadrature conductivity, σ^{X}, can be given as:

$${σ}^{X} = - \frac{2}{3} {β}_{+ ( T , S )}^{s} {f}_{( S )} {ρ}_{g} {S}_{w}^{{n}^{*} - 1} CEC \qquad eq . 7$$

where

$${β}_{+ ( T , S )}^{s}$$

is the counterion mobility in the Stern layer, f_{(S)} is the fraction of counterions in the Stern layer, ρ_{g} is the grain density (e.g., formation grain density), S_{w} is the saturation and CEC is the bulk clay CEC value, n* is the saturation exponent for shaly sand formations, T is temperature and S is salinity.

The aforementioned constants can be determined from fitting lab data as obtained at low frequency for the purpose of measuring interfacial polarization (IPol) effects where such constants tend to be well established and valid for electromagnetic conductivity frequencies. The so-called Revil constants

$${β}_{+ ( T , S )}^{s}$$

and f_{(S)} are a function of connate water salinity and temperature; noting that analytical equations have been developed for both.

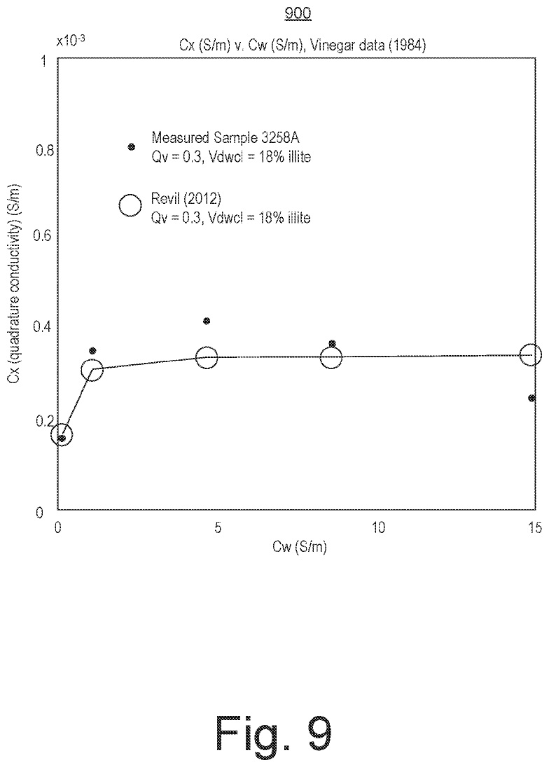

FIG. 9 shows an example plot 900 of the quadrature conductivities (Cₓ) as a function of connate water conductivity (C_{w}) and the forward model using eqs. 3 and 7 for core sample 3258A of Vinegar (1984). The parameters for the equations are known from lab measurements or computed. In the plot 900, the Revil model using eqs. 3 and 7 for core sample 3258A is shown using circles connected with solid lines. As demonstrated, the Revil model replicates the measured conductivities reasonably well.

As explained with respect to the plot 510 of FIG. 5, in the Maxwell-Wagner range of frequencies, physical phenomena can include polarization of surface charges of platy grains. As an example, clay and other conductive minerals such as pyrite and graphite may contribute to dispersion in the dielectric at the higher end of the frequency ranges (see, e.g., the hatched bar in the plot 510 of FIG. 5) where IPol effects dominate. For example, dispersion may be seen above approximately 2 kHz and higher. This means the values change with frequency even though the mechanism remains the same, e.g., IPol. In these cases, a method can include a mechanism to account for this dispersion. In Revil (2012), a “chargeability” is utilized to characterize this dispersion; noting that a cole-cole model can be used additionally or alternatively. Such dispersion, however, is practically non-existent in the 30 Hz data, as illustrated in the plot 900 of FIG. 9. When dispersion is present, a method can include utilizing measurements at multiple frequencies to characterize the dispersion, followed by taking the low frequency limit to use in the equations. Another option can be to pre-define the dispersion characteristic as a function of frequency, followed by using such a model to adjust the measurements back to a low frequency limit equivalent followed by using the equations.

As to inversion for petrophysical parameters, eq. 1, eq. 2 and eq. 7 show that two inputs or measurements (σₜ and σ^{X}) exist and generally three or more unknowns of CEC or Qᵥ, connate water conductivity, σ_{w}, and S_{w}; noting that Archie cementation exponent and/or Archie saturation exponent may be considered as members of a group. Thus, in various examples, a group may include five parameters. As explained, if one of these unknowns is known, then the other two parameters can be determined by solving the two equations (eq. 1 and eq. 7) simultaneously after substituting eq. 2 into eq. 1. For example, if using a known value of CEC or Qᵥ, the connate water salinity and S_{w} can be determined simultaneously. As an example, a simultaneous inversion may utilize the Levenberg-Marquardt technique or, for example, one or more other inversion techniques.

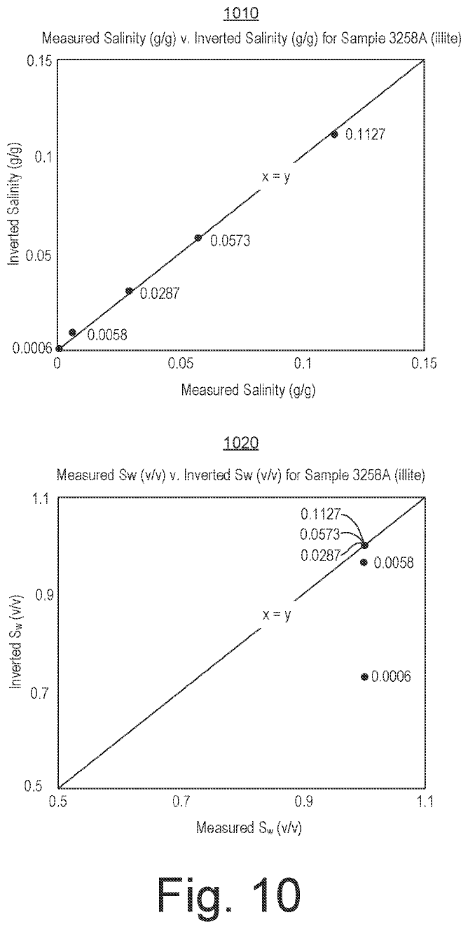

FIG. 10 shows example plots 1010 and 1020 for results of an inversion for core sample 3258A where Qᵥ was measured in the lab and taken as a known parameter and the salinity and S_{w} were solved for simultaneously. Core sample 3258A had measurements of σₜ and σ^{X} taken for 5 different salinities. The Y axis is the measured salinity in g/g and the Y axis is the inverted salinity in g/g. As shown in these examples, the inversion has accurately determined the salinity for the entire range of values. The measured saturations are 1 for the measurements taken and the inverted S_{w} values in the plot 1020 range from 1.01 to 0.97, showing reasonable accuracy.

As mentioned, such a method may be utilized when one of the three formation parameters is known from other sources, calculations, or measurements. For example, CEC and salinity can be inverted for when S_{w} is known. CEC and S_{w} can be inverted for when salinity is known, and finally S_{w} and salinity can be inverted for when CEC is known. As explained, a group can include one or more Archie parameters such as, for example, an Archie saturation exponent and/or an Archie cementation exponent. As an example, a group can be selected from CEC, salinity, water saturation, Archie saturation exponent and Archie cementation exponent. As an example, a group may include three members where two members can be determined via inversion when one member of the group is known.

As explained, a group may include five parameters as in a petrophysical relationship such as a model including Dual Water and Revil relationships (see, e.g., eqs. 1 and 7). As an example, a method can including inverting a model for any two of the five parameters simultaneously using two measured input conductivities.

In fresh connate water situations of low salinity, the measured σₜ and σ^{X} tend to form a unique pattern that can enhance an inversion's sensitivity and ability to determine salinity. At lower connate water salinities, in-phase conductivity increases relative to a formation without clay. As clay content increases, the conductivity increase is enhanced. This phenomenon can be seen in the plot 800 of FIG. 8 where the clay counterions in the clays continue to conduct current even when the connate water salinity decreases towards zero. At very high connate water salinities, in-phase conductivity decreases compared to a formation without clay. Such phenomenon is due to the clay bound water being less saline than the free water (e.g., surrounding the clay). This phenomenon can also be seen in the plot 800 of FIG. 8 where the measured conductivity is less than that predicted for a formation without clay (Archie relationship). These clay conductivity effects are enhanced as both Qᵥ and the porosity increase as eq. 1 and 2 would predict.

In contrast, the quadrature conductivity is relatively constant for all salinities (see, e.g., the plot 900 of FIG. 9), which then drops at the very low salinities, going in the opposite direction compared to the in-phase conductivity. This conductivity drop is due to the number of counterions in the Stern layer decreasing as the salinity decreases (see, e.g., Revil (2012)).

The fact that both measurements react in the opposite direction gives the inversion increased sensitivity for the inversion for connate water salinity in formations having fresher connate water. In these formations it is usually difficult to know the connate water salinity with certainty. Formations under waterflood have a similar issue. The inversion can be a powerful tool to determine the connate water salinity when fresher formation waters are present in a reservoir. Such an approach demands sufficient volumes of clay to be present in the formation to affect the term σ_{we}. Without clay present in the formation, the quadrature conductivity may be too small to measure. Fortunately, most detrital formations have some clay present; noting that carbonate formations may or may not have clay present.

When the clay bound water conductivity equals the free water conductivity the term (σ_{bw(T,S)}−σ_{w(T,S)}) in eq. 2 becomes zero and σ_{we}=σ_{w(T,S)}. In this case the predicted conductivity from eq. 1 and an Archie formulation,

$${σ}_{t} = {ϕ}^{m} {S}_{w}^{n} {σ}_{w}$$

are equal, where n is the Archie saturation exponent (e.g., in a range from approximately 1.8 to approximately 4) and where m is the Archie cementation exponent (e.g., in a range from approximately 1.7 to approximately 3.0). This is the intersection of the lines representing the two relationships in the plot 800 of FIG. 8. For sample 3323C shown in the plot 800 of FIG. 8, this intersection is at approximately 7 S/m. Such an approach provides a means of independently confirming the conductivity of the clay bound water improving the accuracy of any model for saturation analysis such as the Dual Water formulations. Such an approach also demands sufficient volumes of clay to be present in the formation to affect the term σ_{we}.

Experimental lab data show that the in-phase conductivity does not change with frequency. The Revil constants

$$( {β}_{+ ( T , S )}^{s} and {f}_{( S )} )$$

for the quadrature conductivity have been determined from low frequency measurements generally below 10 kHz where the quadrature conductivity is relatively constant (see, e.g., Revil (2012)). Higher frequency measurements can cause the quadrature conductivity to increase and the resulting constants to vary. Using higher frequency measurements at higher frequencies with the appropriate constants for the quadrature conductivity allows unique equations to be used at each frequency by applying these new constants in eq 7. These equations will have a different sensitivity to the clay induced interfacial polarization (IPol) effects and thus will provide sensitivity to the inversion.

As an example, a method can use measured quadrature conductivity in conjunction with measured in-phase conductivity to invert for two of a group of three or more unknown formation parameters, CEC or Qᵥ, S_{w}, and connate water salinity; noting that Archie cementation exponent and/or Archie saturation exponent may be included in a group (e.g., one or more Archie exponent parameters can be considered). In such an example, the method can provide for determination of connate water salinity and S_{w} simultaneously in a reservoir and in particular fresh-water reservoirs or reservoirs under waterflood where the determination of both parameters is useful.

As an example, a method can include determining bound water conductivity experimentally from lab measurements of conductivity at multiple connate water salinities. As an example, a method can include determining bound water conductivity experimentally from downhole measurements of conductivity by taking measurements in formations with the same or similar values of Qᵥ, but having different connate water salinities.

As an example, in-phase and quadrature conductivities may be measured using WL and/or LWD tools. As an example, a downhole assembly can include components such as a processor and memory for inverting measurements to output parameters that characterize a formation. In such an example, where the downhole assembly is a drilling assembly (e.g., a drillstring), one or more drilling and/or fluid operations may be controlled based at least in part on one or more output parameters (e.g., values of parameters or parameter values).

As an example, in-phase and quadrature conductivities can be measured at certain multiple frequencies using WL and/or LWD tools. As an example, the constants

$${β}_{+ ( T , S )}^{s}$$

and f_{(S)} can be determined from lab measurements at one or more chosen frequencies. As an example, a method may be employed at each frequency, which can help to improve accuracy.

As an example, a method can include solving for three unknowns (and up to 4 unknowns) by having both in-phase and quadrature conductivities at two frequencies measured and applying an inversion for each frequency. In such an example, when the frequencies are sufficiently separated such that the constants differ, accuracy can be enhanced.

As an example, measurements at three or more frequencies separated by a sufficient amount can allow for more than four unknowns to be inverted for, each set of measurements allowing for two unknowns to be inverted for. Such an approach can depend on parameters that change with frequency resulting in conductivity and dielectric changing with frequency to impart differing character to the data.

As an example, a method can include determining S_{w}, CEC, and salinity from one or more frequency ranges where Maxwell-Wagner effects dominate, where an appropriate model can be used for conductivity and dielectric response of a formation.

As an example, a method can provide for real-time determination of CEC as a parameter that is indicative of clay type, for example, when clay volume is known, which may be computed from one or more other measurements. Clay type can dictate drilling fluid (mud) characteristics. For example, a method can include determining what mud additives can be utilized to help reduce undesirable clay swelling, which may create borehole instability issues. As an example, a method can include characterizing borehole stability and controlling one or more operations based on borehole stability. As mentioned, a method can provide for making determinations as to drilling fluid (mud), which can include composition, density, viscosity, salinity, etc., and/or determinations as to flow rate of drilling fluid (mud). In various drilling operations, a mud motor may be utilized where the flow of mud powers the mud motor for rotation of a drill bit. In such operations, drilling fluid may be tailored and pumped to control drilling while also stabilizing a formation surrounding a borehole (e.g., a borehole wall). Stability issues can impact drilling, completions, etc., where an ability to address stability in an upstream manner (e.g., at the time of drilling) can result in substantial savings and reduced risk of issues.

As an example, a method can include real-time determination of water saturation, which may be used to determine an optimal length of a lateral well. For example, if an insufficient hydrocarbon volume has not been penetrated, the length of the lateral can be extended while drilling to maximize the revenue/cost of the well. In such an approach, a borehole can be characterized with respect to reservoir contact, which is the area or length of the borehole that is in contact with a reservoir for production of fluid.

As explained, a method can include assessing one or more types of reservoirs. For example, consider a reservoir that includes water and brine, which may be assessed for one or more purposes such as, for example, carbon storage (e.g., sequestration), water production or storage, geothermal production or storage, metallic extraction from brine, etc. In such examples, one or more operations may be planned, controlled, executed, etc., based on an inversion for values of formation parameters utilizing measurements acquired from one or more ECM tools.

As an example, a method can include utilizing salinity to characterize a formation. For example, salinity of certain fault blocks can be unique such that real-time salinity can be used to identify crossing of a fault or faults, which may not be apparent using other measurements such as, for example, seismic measurements.

As an example, a method can be employed in a scenario where waterflooding has been implemented. In such an example, formations under waterflood will tend to have water breakthrough in higher permeability layers before lower permeability layers. Through determination of salinity, a method can provide for identification of such layers as the water being used to flood the reservoir is normally of a lower salinity than in-situ connate water.

As explained, various parameters can characterize a formation where such a characterization can be utilized in performing one or more field operations, optionally in real-time. As an example, one or more logs can be generated for parameters and/or for additional parameters that are based at least in part on such parameters. For example, consider a borehole stability log that may be based at least in part on CEC of particles (e.g., clays, etc.) that are in a formation and surrounding a borehole. Such a log may be utilized during drilling, for drilling fluid control, for completions operations, etc. For example, a cementing operation may be controlled using a borehole stability log where one or more aspects of cement and/or pumping thereof can be controlled to address borehole stability.

As an example, one or more characterizations from an electromagnetic conductivity measurement analysis can be utilized in a system such as the system 200 of FIG. 2. For example, consider use in the geo data block 210, the surface models block 220, the volume models block 230, the applications block 240 (e.g., well stability assessment 246, etc.), the numerical processing block 250 and/or the operational decision block 260.

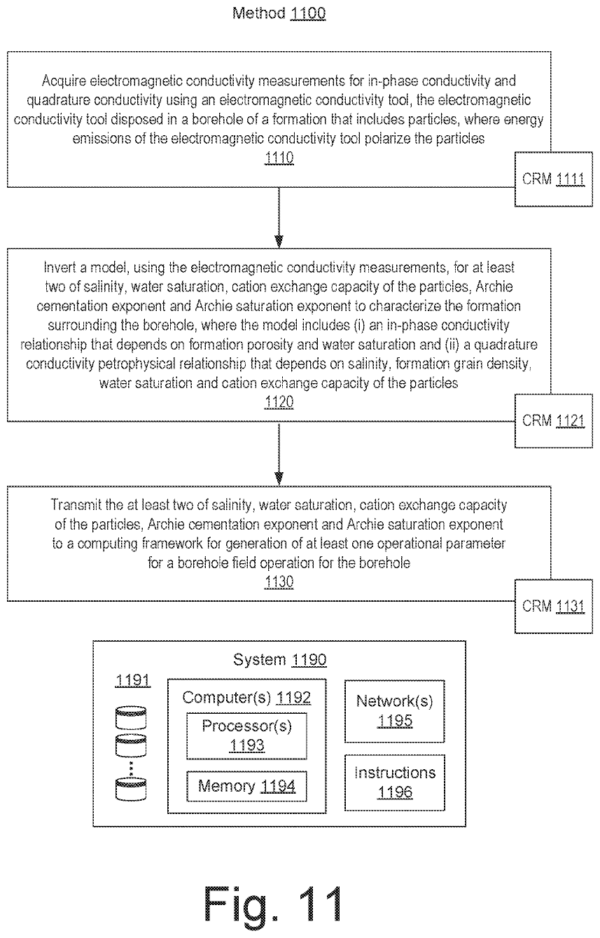

FIG. 11 shows an example of a method 1100 and an example of a system 1190. As shown, the method 1100 can include an acquisition block 1110 for acquiring electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; an inversion block 1120 for inverting a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and a transmission block 1130 for transmitting the at least two of salinity, water saturation, cation exchange capacity of the particles, Archie cementation exponent and Archie saturation exponent to a computing framework for generation of at least one operational parameter for a borehole field operation for the borehole

The method 1100 is shown in FIG. 11 in association with various computer-readable media (CRM) blocks 1111, 1121 and 1131. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1100. As an example, a computer-readable medium (CRM) may be a computer-readable storage medium that is non-transitory and that is not a carrier wave. As an example, one or more of the blocks 1111, 1121 and 1131 may be in the form processor-executable instructions.

In the example of FIG. 11, the system 1190 includes one or more information storage devices 1191, one or more computers 1192, one or more networks 1195 and instructions 1196. As to the one or more computers 1192, each computer may include one or more processors (e.g., or processing cores) 1193 and memory 1194 for storing the instructions 1196, for example, executable by at least one of the one or more processors 1193 (see, e.g., the blocks 1111, 1121 and 1131). As an example, a computer may include one or more network interfaces (e.g., wired or wireless), one or more graphics cards, a display interface (e.g., wired or wireless), etc.

As an example, a method can include acquiring electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; inverting a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmitting the at least two of salinity, water saturation, cation exchange capacity of the particles, Archie cementation exponent and Archie saturation exponent to a computing framework for generation of at least one operational parameter for a borehole field operation for the borehole.

As an example, a method can include, where an estimated amount of clay of the particles is less than a clay threshold, setting a dielectric value of particles to zero, assuming values for salinity and water saturation, and inverting a model for cation exchange capacity of the particles based at least in part on the assumed values.

As an example, particles can include clay. For example, consider one or more of diatomite, montmorillonite-smectite, illite, chlorite, and kaolinite.

As an example, a method can include performing inverting using a processor operatively coupled to an electromagnetic conductivity tool. For example, consider a tool string that includes one or more processors and memory accessible to at least one of the processors where the memory can include instructions to perform an inversion for two or more parameters of a group of parameters using conductivity measurements acquired by an electromagnetic conductivity tool.

As an example, operational parameters can include a drilling fluid salinity parameter. In such an example, the drilling fluid salinity parameter can be set to a value that can increase drilling fluid salinity, for example, to stabilize a borehole by controlling swelling of the particles of the formation. As an example, particles can include smectite where swelling of the smectite depends on salinity of fluid to which the smectite is exposed.

As an example, operational parameters can include a drilling parameter that controls interaction of a drill bit and the formation. For example, consider a method that can perform an inversion to characterize a borehole wall where such a characterization may indicate a risk of collapse, for example, via geomechanical analysis (e.g., modeling, simulation, etc.), where drilling can be controlled based on the risk of collapse. As an example, at least one operational parameter can include a drilling parameter that controls geosteering of a drill bit for interaction of the drill bit and the formation. In such an example, a method can provide for geosteering that aims to maintain a drill bit within a formation layer such as, for example, a reservoir layer (e.g., by providing guidance as to one or more boundaries of the reservoir layer, etc.). As an example, drilling may be controlled by terminating a larger bore portion and by commencing a smaller bore portion where drilling of a smaller bore lessens geomechanical stresses, etc., on a formation and hence a borehole wall formed by the formation.

As an example, operational parameters can include a completions parameter where a borehole field operation can be a borehole completion operation that forms a formation barrier. For example, consider installation of casing where cementing may be performed to create a layer of cement between an outer surface of the casing and a borehole wall formed by a formation. In such an example, the casing and/or the cement can form a formation barrier. As an example, a casing operation can depend on borehole wall characteristics, which can be determined from an inversion using electromagnetic conductivity measurements. Where a borehole wall includes a certain type of material (e.g., certain particles), cement type, cement thickness, casing type, casing thickness, etc., may be selected based at least in part on the type of material.

As an example, a method can include transmitting information via implementation of borehole telemetry using a telemetry system. For example, consider a wired telemetry system or a wireless telemetry system. An example of a wireless telemetry system can be mud-pulse telemetry where pressure waves are imparted to drilling fluid (mud) for transmission uphole to surface equipment or other equipment.

As an example, an electromagnetic conductivity tool can be a logging while drilling tool mounted to a drillstring. As an example, a computational framework can include a drilling framework that controls the borehole field operation. In such an example, the computational framework may be subsurface (e.g., downhole) and/or surface. As an example, a method can include acquiring, inverting and transmitting activities that occur during a borehole field operation, which may be, for example, a drilling operation, a completions operation, a fracturing operation that fractures a formation, a perforating operation that perforates a tubular for fluid communication with a formation, etc.

As an example, a method can include generating at least one log with respect to measured depth of a borehole using at least two of salinity, water saturation, cation exchange capacity of particles, Archie cementation exponent and Archie saturation exponent.

As an example, a system can include a processor; memory accessible to the processor; and processor-executable instructions stored in the memory to instruct the system to: acquire electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; invert a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmit the at least two of salinity, water saturation, cation exchange capacity of the particles, Archie cementation exponent and Archie saturation exponent to a computing framework for generation of at least one operational parameter for a borehole field operation for the borehole. In such an example, the processor, the memory and the electromagnetic conductivity tool can be part of a downhole assembly.

As an example, a system can include processor-executable instructions stored in memory to instruct the system to transmit at least two of salinity, water saturation, cation exchange capacity of the particles, Archie cementation exponent and Archie saturation exponent responsive to a trigger. For example, consider a trigger that is based at least in part on a change in a value, a comparison of a value to a threshold, a memory full indicator, a telemetry available indicator, a halt drilling indicator, etc. In such an example, upon receipt of transmitted values, a system may decide to continue a borehole operation such as drilling, completing, etc.

As an example, one or more non-transitory computer-readable storage media can include processor-executable instructions to instruct a computing system to: acquire electromagnetic conductivity measurements for in-phase conductivity and quadrature conductivity using an electromagnetic conductivity tool, the electromagnetic conductivity tool disposed in a borehole of a formation that includes particles, where energy emissions of the electromagnetic conductivity tool polarize the particles; invert a model, using the electromagnetic conductivity measurements, for at least two of salinity, water saturation, cation exchange capacity of the particles, Archie cementation exponent and Archie saturation exponent to characterize the formation surrounding the borehole, where the model includes (i) an in-phase conductivity relationship that depends on formation porosity and water saturation and (ii) a quadrature conductivity petrophysical relationship that depends on salinity, formation grain density, water saturation and cation exchange capacity of the particles; and transmit the at least two of salinity, water saturation, cation exchange capacity of the particles, Archie cementation exponent and Archie saturation exponent to a computing framework for generation of at least one operational parameter for a borehole field operation for the borehole. In such an example, the one or more non-transitory computer-readable storage media can include processor-executable instructions to instruct the computing system to characterize the formation surrounding the borehole with respect to borehole stability. For example, borehole stability can depend on swellability of the particles in relationship to salinity.

As an example, a computer program product can include one or more computer-readable storage media that can include processor-executable instructions to instruct a computing system to perform one or more methods and/or one or more portions of a method.

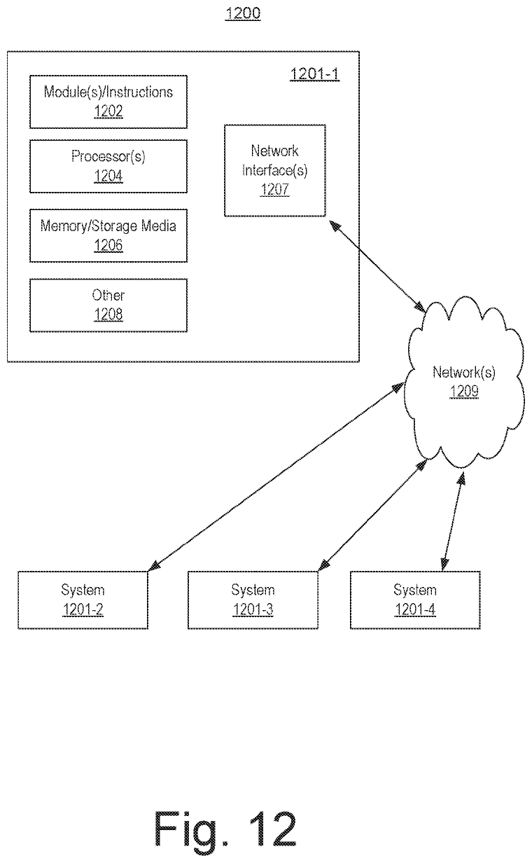

In some embodiments, a method or methods may be executed by a computing system. FIG. 12 shows an example of a system 1200 that can include one or more computing systems 1201-1, 1201-2, 1201-3 and 1201-4, which may be operatively coupled via one or more networks 1209, which may include wired and/or wireless networks. As shown, the system 1200 can include one or more other features 1208.

As an example, a system can include an individual computer system or an arrangement of distributed computer systems. In the example of FIG. 12, the computer system 1201-1 can include one or more modules 1202, which may be or include processor-executable instructions, for example, executable to perform various tasks (e.g., receiving information, requesting information, processing information, simulation, outputting information, etc.).

As an example, a module may be executed independently, or in coordination with, one or more processors 1204, which is (or are) operatively coupled to one or more storage media 1206 (e.g., via wire, wirelessly, etc.). As an example, one or more of the one or more processors 1204 can be operatively coupled to at least one of one or more network interface 1207. In such an example, the computer system 1201-1 can transmit and/or receive information, for example, via the one or more networks 1209 (e.g., consider one or more of the Internet, a private network, a cellular network, a satellite network, etc.).

As an example, the computer system 1201-1 may receive from and/or transmit information to one or more other devices, which may be or include, for example, one or more of the computer systems 1201-2, etc. A device may be located in a physical location that differs from that of the computer system 1201-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1206 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in machine running machine-readable instructions or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

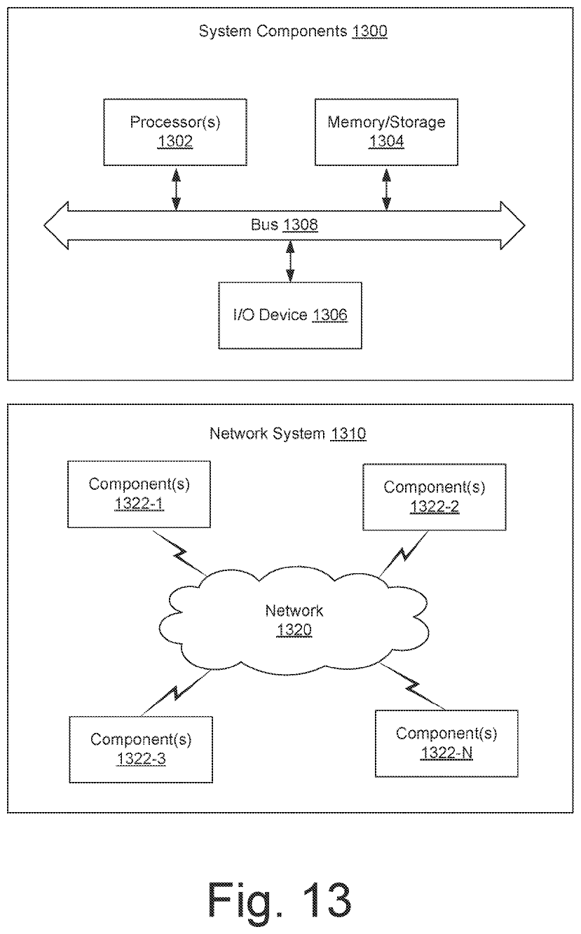

FIG. 13 shows components of an example of a computing system 1300 and an example of a networked system 1310 with a network 1320. As an example, a system for detection of carbonates can include various features of the system 1300 and/or the system 1310 of FIG. 13 and/or be operatively coupled to one or more instances of the system 1300 and/or the system 1310 of FIG. 13.

In FIG. 13, the system 1300 includes one or more processors 1302, memory and/or storage components 1304, one or more input and/or output devices 1306 and a bus 1308. In an example embodiment, instructions may be stored in one or more computer-readable media (e.g., memory/storage components 1304). Such instructions may be read by one or more processors (e.g., the processor(s) 1302) via a communication bus (e.g., the bus 1308), which may be wired or wireless. The one or more processors may execute such instructions to implement (wholly or in part) one or more attributes (e.g., as part of a method). A user may view output from and interact with a process via an I/O device (e.g., the device 1306). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1310. The network system 1310 includes components 1322-1, 1322-2, 1322-3, . . . 1322-N. For example, the components 1322-1 may include the processor(s) 1302 while the component(s) 1322-3 may include memory accessible by the processor(s) 1302. Further, the component(s) 1322-2 may include an I/O device for display and optionally interaction with a method. The network 1320 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
acquiring electromagnetic conductivity measurements for in-phase conductivity and quadrature conductivity using an electromagnetic conductivity tool, the electromagnetic conductivity tool disposed in a borehole of a formation that comprises particles, wherein energy emissions of the electromagnetic conductivity tool polarize the particles;
inverting a model, using the electromagnetic conductivity measurements, for at least two of salinity, water saturation, cation exchange capacity of the particles, Archie cementation exponent and Archie saturation exponent to characterize the formation surrounding the borehole, wherein the model comprises (i) an in-phase conductivity relationship that depends on formation porosity and water saturation and (ii) a quadrature conductivity petrophysical relationship that depends on salinity, formation grain density, water saturation and cation exchange capacity of the particles; and
transmitting the at least two of salinity, water saturation, cation exchange capacity of the particles, Archie cementation exponent and Archie saturation exponent to a computing framework for generation of at least one operational parameter for a borehole field operation for the borehole.

2. The method of claim 1, wherein an estimated amount of clay of the particles is less than a clay threshold, and the method further comprises setting a dielectric value of the particles to zero, assuming values for salinity and water saturation, and performing the inverting of the model for cation exchange capacity of the particles based at least in part on the assumed values.

3. The method of claim 1, wherein the particles comprise clay.

4. The method of claim 3, wherein the clay comprises one or more of diatomite, montmorillonite-smectite, illite, chlorite, and kaolinite.

5. The method of claim 1, further comprising performing the inverting using a processor operatively coupled to the electromagnetic conductivity tool.

6. The method of claim 1, wherein the at least one operational parameter comprises a drilling fluid salinity parameter.

7. The method of claim 6, wherein the drilling fluid salinity parameter increases drilling fluid salinity to stabilize the borehole by controlling swelling of the particles of the formation.

8. The method of claim 6, wherein the particles comprise smectite.

9. The method of claim 1, wherein the at least one operational parameter comprises a drilling parameter that controls geosteering of a drill bit for interaction of the drill bit and the formation.

10. The method of claim 1, wherein the at least one operational parameter comprises a completions parameter wherein the borehole field operation comprises a borehole completion operation that forms a formation barrier.

11. The method of claim 1, wherein the electromagnetic conductivity tool is a logging while drilling tool mounted to a drillstring.

12. The method of claim 1, wherein the computing framework comprises a drilling framework that controls the borehole field operation.

13. The method of claim 1, wherein the acquiring, the inverting and the transmitting occur during the borehole field operation.

14. The method of claim 1, further comprising generating at least one log with respect to measured depth of the borehole using the at least two of salinity, water saturation, cation exchange capacity of the particles, Archie cementation exponent and Archie saturation exponent.

15. A system comprising:
a processor;
memory accessible to the processor; and
processor-executable instructions stored in the memory to instruct the system to:
acquire electromagnetic conductivity measurements for in-phase conductivity and quadrature conductivity using an electromagnetic conductivity tool, the electromagnetic conductivity tool disposed in a borehole of a formation that comprises particles, wherein energy emissions of the electromagnetic conductivity tool polarize the particles;
invert a model, using the electromagnetic conductivity measurements, for at least two of salinity, water saturation, cation exchange capacity of the particles, Archie cementation exponent and Archie saturation exponent to characterize the formation surrounding the borehole, wherein the model comprises (i) an in-phase conductivity relationship that depends on formation porosity and water saturation and (ii) a quadrature conductivity petrophysical relationship that depends on salinity, formation grain density, water saturation and cation exchange capacity of the particles; and
transmit the at least two of salinity, water saturation, cation exchange capacity of the particles, Archie cementation exponent and Archie saturation exponent to a computing framework for generation of at least one operational parameter for a borehole field operation for the borehole.

16. The system of claim 15, wherein the processor, the memory and the electromagnetic conductivity tool are part of a downhole assembly.

17. The system of claim 15, further comprising processor-executable instructions stored in the memory to instruct the system to transmit the at least two of salinity, water saturation, cation exchange capacity of the particles, Archie cementation exponent and Archie saturation exponent responsive to a trigger.

18. One or more non-transitory computer-readable storage media comprising processor-executable instructions to instruct a computing system to:
acquire electromagnetic conductivity measurements for in-phase conductivity and quadrature conductivity using an electromagnetic conductivity tool, the electromagnetic conductivity tool disposed in a borehole of a formation that comprises particles, wherein energy emissions of the electromagnetic conductivity tool polarize the particles;
invert a model, using the electromagnetic conductivity measurements, for at least two of salinity, water saturation, cation exchange capacity of the particles, Archie cementation exponent and Archie saturation exponent to characterize the formation surrounding the borehole, wherein the model comprises (i) an in-phase conductivity relationship that depends on formation porosity and water saturation and (ii) a quadrature conductivity petrophysical relationship that depends on salinity, formation grain density, water saturation and cation exchange capacity of the particles; and
transmit the at least two of salinity, water saturation, cation exchange capacity of the particles, Archie cementation exponent and Archie saturation exponent to a computing framework for generation of at least one operational parameter for a borehole field operation for the borehole.

19. The one or more non-transitory computer-readable storage media of claim 18, further comprising processor-executable instructions to instruct the computing system to characterize the formation surrounding the borehole with respect to borehole stability.

20. The one or more non-transitory computer-readable storage media of claim 19, wherein the borehole stability depends on swellability of the particles in relationship to salinity.
